(19) United States
(12) Patent Application Publication
(10) Pub. No.: US 2024/0278458 A1
(43) Pub. Date: Aug. 22, 2024

(54) DRY WALL MANUFACTURING METHOD AND APPARATUS

(71) Applicant: Roger A. May, Kentwood, MI (US)

(72) Inventor: Roger A. May, Kentwood, MI (US)

(21) Appl. No.: 18/438,789

(22) Filed: Feb. 12, 2024

(30) Foreign Application Priority Data
Feb. 11, 2023 (US) 63444917

(51) Int. Cl. B28B 11/08; B28B 19/00; E04C 2/00

(52) U.S. Cl. CPC B28B 11/0863; B28B 19/0092; E04C 2002/004

(57) ABSTRACT

As an elongated laminate of paper faced gypsum being produced into drywall boards is advanced along a conveyor to a point at which the gypsum is dried to a water content such that the laminate can be embossed by an embossing roller which can be pressed into the laminate for a sufficient time and depth to form a embossed channel which is about the lateral width of a piece of drywall tape which would be used to tape the ends of two separate abutting drywall pieces when being hung and taped, and a depth sufficient to accommodate a strip of drywall tape within said embossed channel. The embossing step is done on the underside of said advancing laminate at a distance from a shear used for shearing the laminate into pieces of drywall, that the center line of the embossed channel bottom wall formed by said embossing roller is located the distance the advancing laminate has to travel to shear the individual drywall pieces being produced to a desired length, or a multiple thereof.

### RELATED APPLICATIONS/PRIORITY BENEFIT CLAIM

This application claims priority to Provisional Application Ser. No. 63/444,912, filed Feb. 11, 2023, the content of which is incorporated herein by reference.

### BACKGROUND OF THE INVENTION

The present invention relates to drywall and methods of producing it. Drywall is often called wall board, or just board. Drywall or wall board or board includes a core of gypsum 10 pressed between a face paper layer 11 and a back paper layer 12 (see prior art FIG. 1). Fabrication of drywall board 1 consists of unrolling a roll of face paper 11 (hereinafter “face layer 11”), usually 4 feet wide, onto a conveyor belt 5 moving at about 480 feet per minute, spreading a slurry of water and dehydrated gypsum 10 onto the moving face layer 11, and unrolling a back paper layer 12 (hereinafter “back layer 12”) onto the dehydrated gypsum slurry 10 as it is moving such that a laminate 2 is formed which is being carried on the moving conveyor belt 5. The slurry is formulated such that most of the water will react with the dehydrated gypsum to form a hard gypsum core as the center of the laminate.

The newly formed laminate 2 is passed under a large compression roller which presses laminate 2 against conveyor belt 5. One or several compression rollers may be used to compress laminate 2 until it is compressed to the desired thickness for the board 1. The most common thicknesses for wall board 1 are 0.37 inch (9.5 mm), 0.5 inch (12.7 mm), and 0.62 inch (15.7 mm). Typically the side to side width of the board will be 48 inches, the typical width to which drywall is made.

Depending on the variety of wallboard being produced, certain additives are blended with gypsum slurry that will form the core 10 of the drywall 1. Water is added to form a slurry of the proper consistency. Various other additives may be added to this slurry formulation during mixing, e.g. an asphalt emulsion and/or a wax emulsion may be added to achieve the desired level of moisture resistance in the final product; a foaming agent such as a detergent may be included such that during the mixing process air is entrained into the material; and glass fibers may be added to the wet core material when making fire rated gypsum board.

In the manufacturing process, the drywall 1 is made and pressed upside down, supported on a plurality of successive sets of supporting conveyor belts 5. Thus, the laminate is made of a slurry of gypsum 10 pressed between a bottom face paper layer 11, and a top back paper layer 12.

Conveyor lines 3 consisting of successive sets of supported, driven sets of conveyor belts 5 typically extend for 800 feet (93-247 m) between the compression roll(s) and the shear 30 which cuts the laminate 2 into individual pieces of drywall 1, or individual lengths of laminate which are removed from the conveyor line 3 and then cut into individual boards. The conveyor line 3 must be long enough, considering the speed at which the conveyor belt 5 is moving, to allow the gypsum layer 10 to cure to sufficiently dry and hard that it can be cleanly sheared into individual boards 1 of a desired length, which is typically 8 ft, 10 ft, or 12 ft. Thus the laminate 2 will be 800 feet long before it is cut into individual pieces.

During this process, manufacturers wrap the edges of laminate 2 by folding and lapping bottom paper layer 11 and top paper layer around the edges. They also taper the laminate towards its edges to form sloping edge portions 10a on the advancing laminate (see FIG. 1). This may be accomplished for example by providing a has a sloped raised rib towards each edge of at least one of the early conveyor belt sets 5a, which forms sloped edge 10a towards the edges of laminate 2. The laminate 2 still has sufficient moisture that it can be shaped along its edge as shown. FIG. 1 shows two separate pieces of finished drywall being placed such that their sloping edge portions 10a are abutting. This creates an advantageous valley which will be discussed below.

After the individual panels 2 are cut from the laminate, they are transferred to a second conveyor 3a that feeds them through a long, drying oven. For example, a typical gas-fired oven is 470 feet (143 m) long. Panels enter the oven at 500° F. (260° C.) and are exposed to gradually decreasing levels of heat during the 35-40 minutes they travel through the system. Humidity and temperature are carefully controlled in the dryer. The final product is essentially moisture free. Drywall having even 1% moisture is often considered moisture compromised. Some manufacturers shear once and just score at the desired board length 2 or three times between complete shearing so that larger pieces of laminate can be dried in the drying oven as one piece and separated into 3 or 4 individual boards 1 after drying.

The advantage of the tapered edge portions 10a are that when two pieces of drywall are abutted at their edges as shown in FIG. 1, there is a slight depression formed by the abutting tapers into which wet plaster, typically referred to as “mud 11b,” is first applied, followed by the application of a piece of drywall tape 12, and then followed by several additional layers of mud 11b, with the joint being sanded between layer applications.

Where the elongated laminate 2 is cut laterally into individual pieces of drywall, there is no taper (see prior art FIG. 2). Consequently, taping and mudding the abutting end joints requires spreading the mud 11b laterally from the joint several inches to either side of the joint and tape 12 (FIG. 2). This helps create the illusion of flatness at the end joints, even though the mud 11b and drywall tape 12 are raised up relative to the remainder of the flat surface of the drywall.

### SUMMARY OF THE INVENTION

The present invention comprises an apparatus and method for making drywall by embossing a lateral embossed channel into a in a laminate 2 passing an embossing station 35 on its laminate conveyor line 3. As an elongated laminate of paper faced gypsum core is advanced during the manufacturing process, a roller oriented laterally across the width of the laminate is pressed into the underside of the passing laminate 2 for sufficient time to emboss the advancing laminate with an embossed channel in the surface of the laminate. The channel has a width which is about the width of a piece of drywall tape which would be used to tape the abutting ends of two separate abutting drywall pieces when being hung and taped. The embossed channel is embossed into the surface of the laminate to a depth sufficient to accommodate a strip of drywall tape and “mud” therein. The embossing roller is located a distance from the compression roller that the gypsum in the laminate is still sufficiently moist to allow the embossed channel to be impressed into the laminate without breaking or disrupting the surface of the laminate, other than to the shape of the desired embossed channel.

These and other objects, features and advantages of the invention will be more fully understood and appreciated by reference to the Description of the Preferred Embodiments, and the appended drawings.

### BRIEF DESCRIPTION OF THE DRAWINGS

FIG. 1 is a cross section and perspective view of two pieces of side edge abutting prior art drywall;

FIG. 2 is a cross section of two pieces of end edge abutting prior art drywall, showing the application of mud 11b and drywall tape 11a to the joint;

FIG. 3 is a fragmentary perspective view of a wallboard production line proceeding from left to right on the page, showing embossing station 35 (without conveyor belt 5 and linear displacement indicator 110a), and shear station 50;

FIG. 3a is an enlarged portion of FIG. 3 showing the shape of the embossed channel 2a which is formed in the passing laminate 2;

FIG. 4 is a cross sectional view of two endwise abutting pieces of drywall made in accordance with the present invention before taping and mudding;

FIG. 5 is the same cross section as FIG. 4 after taping and mudding;

FIG. 6 is a side elevation of a portion Embossing Station 35 with a specific alternative embossment roller lift 36a;

FIG. 7 is a control schematic for the preferred embodiment apparatus;

FIG. 8 is a view of a shear station 50 for shearing laminate 2.

### DESCRIPTION OF THE PREFERRED EMBODIMENTS

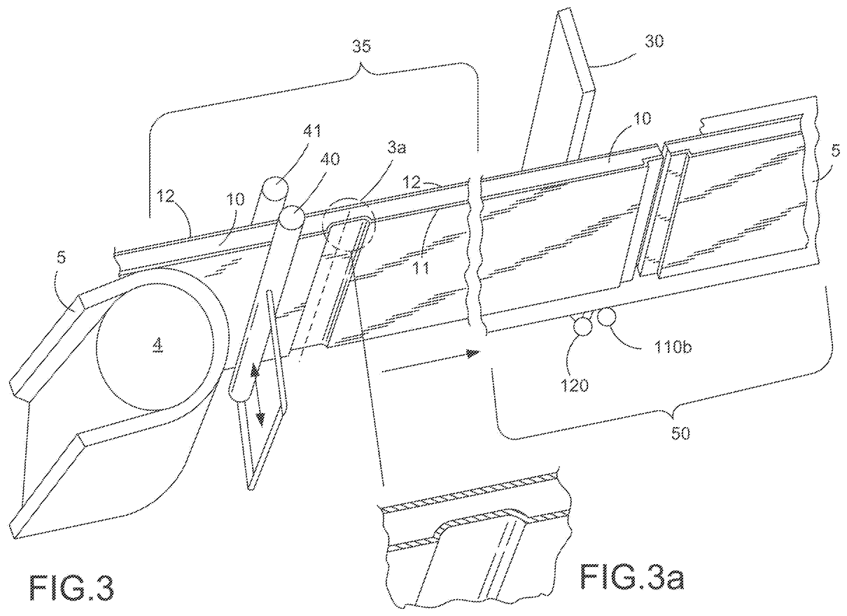

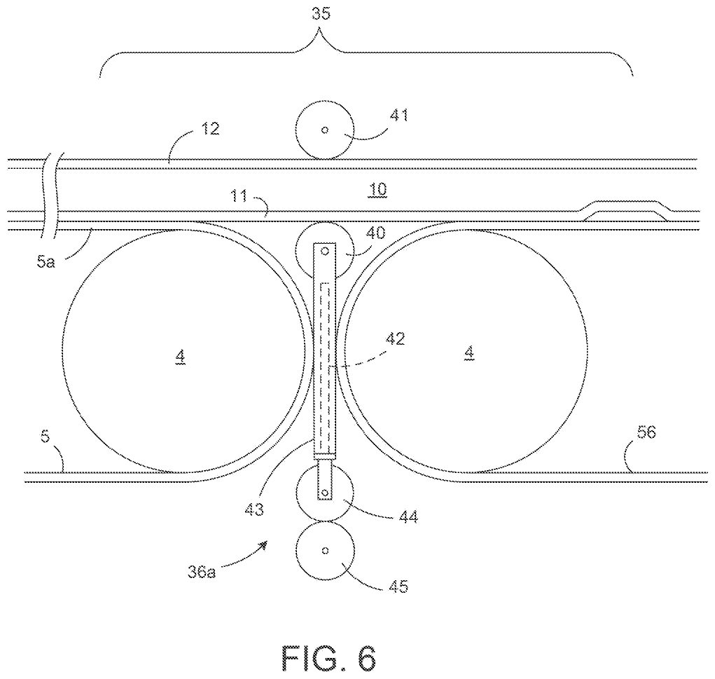

The laminate 2 being processed is carried “upside down” (as described above) supported on a plurality of sets of supporting conveyor belts 5 which are advanced on drive rollers 4 (FIGS. 3, 6) by a conveyor drive 3a (not shown). Rollers 4 are typically about 4 feet in diameter. Each conveyor 3 set has a roller 4 at each end which its conveyor belt 5 is carried around in a continuous loop. Where one conveyor set 3 ends, another begins. At that point, there is a space between the drive roller 4 of the prior conveyor belt 5 set and the drive roller 4 of the succeeding conveyor belt 5 set. Typically, that space will be about a foot between the closest points on the rollers 4, to about 3 feet between the tops of the rollers 4. In that space the advancing laminate 2 is passed from the top of the of the prior roller 4 to the top of the succeeding roller 4 unsupported by any conveyor belt 5 (FIGS. 3, 6).

In the preferred embodiment, the embossing of the upside down laminate 2 is accomplished from below by pressing an embossing roller 40 up into the face layer under side of the laminate 2. This step is accomplished at the point in the length of laminate 2 when the gypsum core 10 still has a moisture content sufficient to allow the embossing roller 40 to be impressed into the underside of the laminate 2 to form embossed channel 2a, without breaking or disrupting the face layer 11 of the laminate, and yet is sufficiently dry that embossing does not cause the laminate to break apart. At that point, an embossing station 35 is located at the gap between a prior conveyor roller 4 and the succeeding roller 4 (FIGS. 3, 6). The embossing station 35 comprises:
a. an embossing roller 40 oriented laterally across the underside of the width of board 1,
b. a fixedly mounted backing roller 41 which extends laterally all the way across the top side of laminate 2 directly opposite embossing roller 40,
c. a lift 36 for raising the embossing roller 40 up into laminate 2 such that it embosses embossed channel 2a in laminate 2.

Lift 36 can be a hydraulic lift, compressed air lift, a mechanical lift or other type of device which will lift embossing roller 40 a sufficient distance to form embossed channel 2a in laminate 2. Backing roller 41 is fixedly mounted on a frame (not shown) such that it does not move up or down, but rather always lightly engages the backing layer 12 surface of the advancing laminate 2 that it prevents laminate 2 from deforming under the pressure of the embossing roller 40, except to the extent necessary to form embossed channel 2a. Embossing roller 40 also preferably continuously engages the face layer 11 surface of the underside of laminate 2, but it is moved up by lift 36 sufficiently and for a sufficient time to emboss channel 2a into laminate 2.

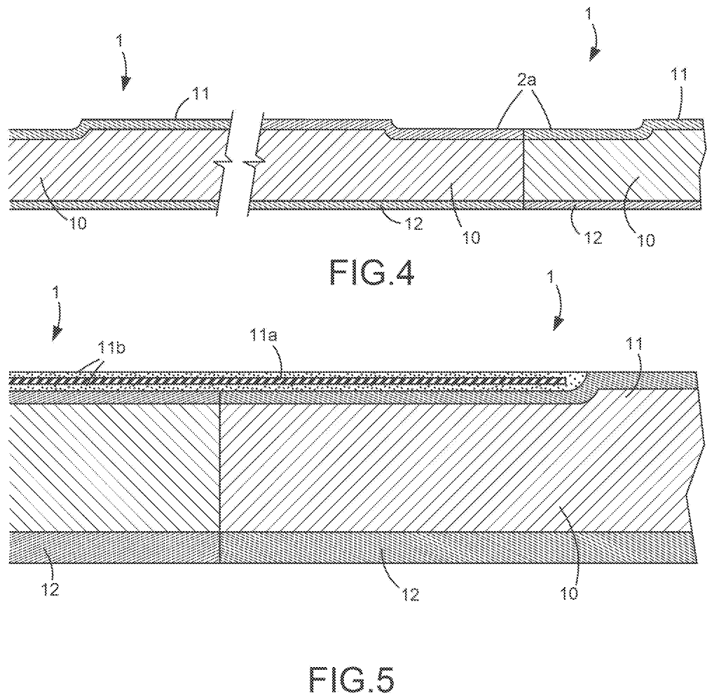

As the laminate 2 passes through the space between prior and succeeding conveyor rolls 4, the embossing roller 40 is raised by lift 36. This presses the embossing roller into the underside of the passing laminate 2 to a sufficient depth and for sufficient time to emboss the advancing board with an embossed channel 2a (FIGS. 3a, 4 and 5). The embossed channel 2a is embossed into the surface of the laminate to a depth sufficient to accommodate a strip of drywall tape 11a and at least one layer of mud 11b therein. Preferably channel 2a has a width which is about the width of a piece of drywall tape 11a (typically two inches) which would be used to tape the ends of two separate abutting drywall pieces 1 when being hung and taped. Preferably, embossed channel 2a is sufficiently wider than a two inch wide drywall tape 11a such that the applicator doesn't have to be precise in positioning the tape 11a in channel 2a. L

Lift 36 must be timed to repeat this process every time the length desired for each of the drywall boards 1 the manufacturer desires to produce. Typically, drywall boards are produced to be 8, 10, or 12 feet long.

Because the laminate must be significantly harder to be sheared than it must be to be embossed, shear 30 is located a substantial distance “d” from embossing station 35 and embossing roller 40, typically 600 feet (FIG. 3). Some manufacturers cut the laminate 2 into long sections, e.g. 100 feet long, and then put them through a dryer on a conveyor 3. After drying, the long segments are cut with a shear 30 into multiple boards of the desired length, e.g. 10 feet long.

Some manufacturers leave them on the oven conveyor 3a after it leaves the drying oven, and convey the long segment of laminate to a shear 30 where the laminate segment is cut to the desired length, e.g. every 10 feet, to produce 10 individual pieces of drywall. Some producers convey the long laminate segments to a stop, where the shear 30 is set to shear the board at the desired length from shear 30.

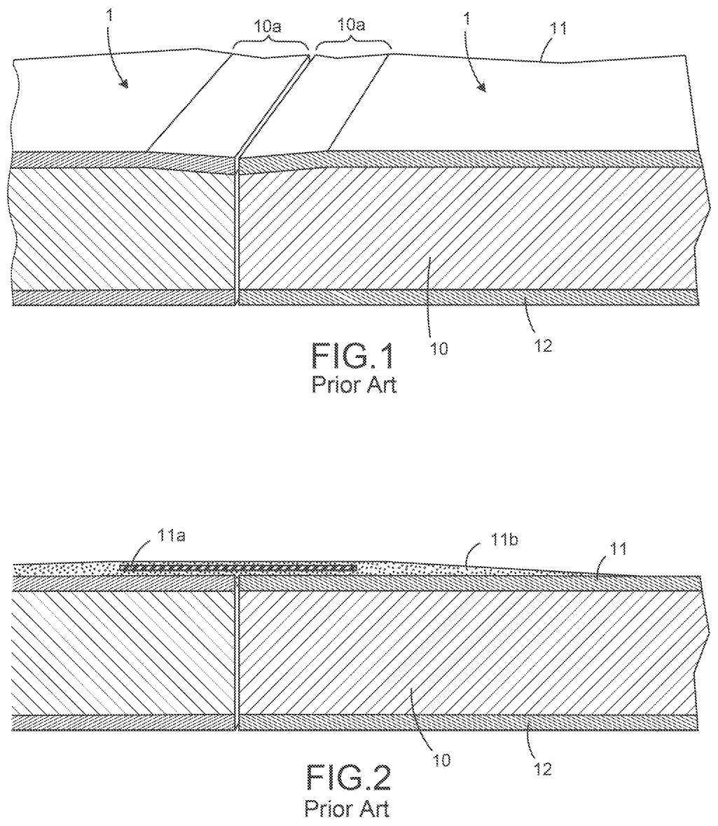

In the present invention, shear 30 must be controlled to shear laminate 2 precisely in the middle of the width of each channel 2a, such that one half channel 2a is located at the end of each drywall board produced. In this way, each board 1 will have a tapered edge 10a on each side, and one half of a channel 2a at each end (see FIGS. 1, 4 and 5). One way to accomplish this is to convey a long laminate segment to a stop, where the shear 30 is set to shear the board at the desired length from shear 30. The shear 30 would be placed to shear precisely in the middle of the width of a channel 2a. However, the long segment would either have to be sheared off the laminate 2 precisely in the middle of the width of a channel 2a, or the long segment would have to be sheared indiscriminately and then trimmed at a channel 2a location and then sheared into multiple boards by shearing in the middle of each channel thereafter.

### Controller 100

In a preferred embodiment of this invention, we describe using a Controller 100 to direct shearing laminate 2 into individual boards of the desired length as the laminate is moving on conveyor 3, or moving on an oven conveyor 3a coming out of the oven without stopping, or moving on any other conveyor 3b beyond conveyor 3.

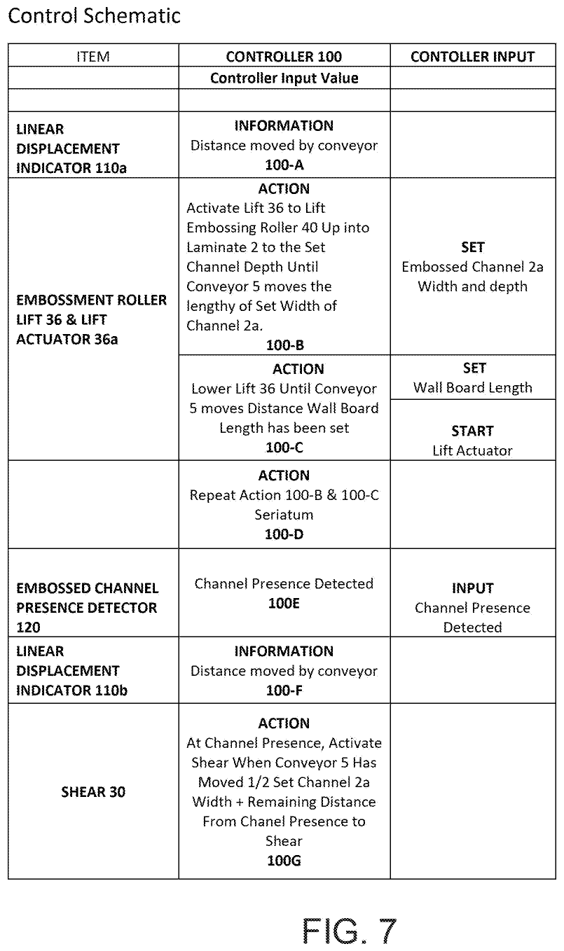

In the preferred embodiment, a controller 100 is provided which controls the manufacture of the drywall 1 made in accordance with the preferred embodiments of this invention is shown schematically in FIG. 7. Controller 100 can be a dedicated controller or a computer programmed by appropriate software. FIG. 7 includes a left hand column which identifies the item of the manufacturing equipment which is being controlled. The right hand column indicates the instruction or other information being input into Controller 100. (The steps listed are not necessary in the order in which they occur.) The center column reports what has been input to the controller 100, or what is being done with the information being input. o

Controller 100 controls a linear displacement indicator 110a which is programed to input various distances which conveyor belt 5 moves. A preferred indicator 110a is a linear displacement encoder. Such encoders are very accurate and very fast. They will be mounted with a displacement indicating wheel engaging the edge portion of conveyor belt 5, thereby informing controller 100 of the distance belt 5 has moved in a given controlled segment of time. See step 100A.

### Operation of Controller 100 at Embossing Station 35

Action steps 100B-100D are performed at embossing station 35 using lift 36, lift actuator 36a, embossing roller 40, operator set width for channel 2a, operator set length desired for wall boards 1, and distance information input by linear displacement indicator 110. A preliminary step in the control process is to input the desired width and depth of channel 2a at step 100B. The depth may actually be a permanent setting, but there may be advantages to be able to “tinker” with it. The width of channel 2a will usually be slightly wider that two inches, as discussed above, and may optionally also be made a permanent setting. Similarly, the desired board 1 length is set and in-putted into controller 100 at step 100C.

The lift actuator 36a (not shown) activates lift 36 to move up into embossing position at the pre-set depth for channel 2a. Lift 36 may be spring loaded or coaxed by gravity to retract downwardly, but the retraction could be directly controlled by lift actuator 36a. The initial activation at 100C would likely be the result of operator input, since this would set the location of the first channel 2a from which the subsequent channels 2a would be embossed.

As indicated at 100B, the first thing activating lift 36 does is to Lift Embossing Roller 40 Up into Laminate 2 to the Set Channel Depth until conveyor belt 5 moves the length of the width of channel 2a. Then as indicated at 100B, controller 100 instructs lift 36 is to be lowered and remain lowered until conveyor belt 5 moves the length which has been set for the desired board length.

At 100D, controller 100 initiates a loop which repeats seriatim the embossing step at 100B and the “at rest” step at 100C. Thus, lateral channels 2a are set into laminate 2 at intervals equal to the length set for each individual drywall panel.

### Operation of Controller 100 at Shear Station 50D

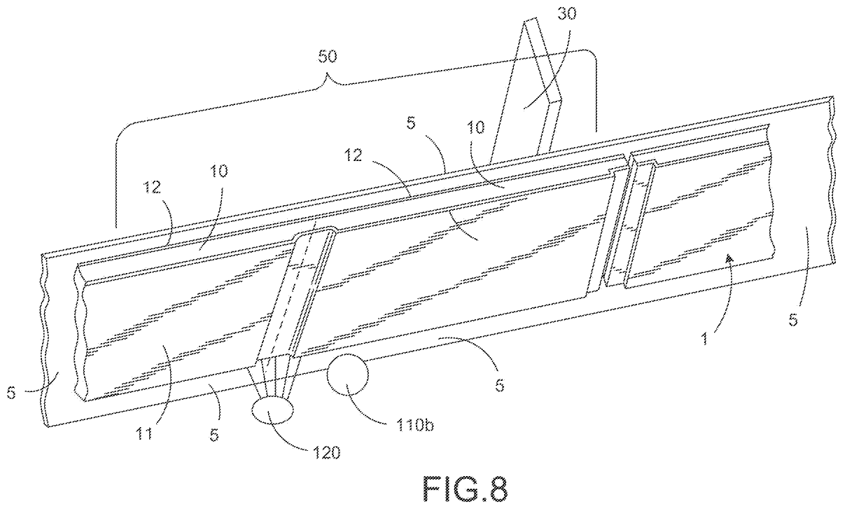

As indicated above at paragraph 29, a preferred embodiment of this invention comprises using Controller 100 to direct shearing the laminate 2 into individual boards of the desired length as the laminate is moving on conveyor 3, or moving on an oven conveyor 3a coming out of the oven without stopping, or moving on any other conveyor 3b beyond conveyor 5. This operation involves using an Embossed Chanel 2a Identifier 120, a second Linear Displacement Indicator 10b, and a Shear 30 at Shear Station 50 (FIG. 8). Embossed Channel Presence detector 120 is preferably a precision electric eye. Linear displacement Indicator is like 110a, preferably a linear displacement encoder with its indicator wheel riding on conveyor belt 5.

FIG. 8 shows Shear Station 50 positioned at the end of conveyor line 3. Accordingly, laminate 2 is still “upside down,” leaving channel 2a on the underside of laminate 2. When a long segment of laminate is cut off at the end of conveyor line 2, it is typically inverted so that channel 2a would be on the top side of laminate 2.

When an embossed channel 2a is detected by Detector 120 in controller step 100E, linear displacement indicator is resets to zero, and shear 30 is activated when conveyor 5 has moved W the set channel 2a width and the remaining distance to shear 30. In this way, individual drywall boards 1 will be produced at step 100G as they come off the end of conveyor 3.

If a producer wants to sever a large section of laminate 2 at the end of conveyor 3, e.g. containing 10 individual boards 1 to be sheared out later, one would modify Controller 100 to ignore the next 9 embossed channels detected by Detector 120, and not reactive shear 30 until the 10′ channel detected. The larger section of laminate 2 would then be sheared into 10 separate Boards 1 either at the end of the dryer oven conveyor 3a, or at the end of some other processing conveyor 3b.

On either oven conveyor 3a or other conveyor 3b, Controller steps 100E and 100G would be repeated seriatim as described in paragraph 38 above. Individual boards would be produced at the end of either conveyor 3a or 3b.

### Other Alternative Embodiments

### Cam Controlled Mechanical Lift 36a.

Lift 36a shown in FIG. 3 is mechanical in nature. Two lifting rods 42 slide up and down in a fixed sleeves 43, one being connected to one end of embossing roller 40 on one side of conveyor 3 to the other end of the embossing roller 40 on the other side of conveyor 3. A follower wheel 44 is mounted on the lower end of each lifting rod 42. Rotating cams 45 in contact with follower wheels 44 are elliptically shaped such that they lift embossing roller into laminate 2 at specified intervals. A variable speed motor and axel assembly (not shown) are operably connected to and driving rotating cams 45, are also operably connected to down-stream shear 30.

In In this embodiment, a linear displacement indicator 110 is not used to control the embossing step 100B. Instead, the speed of the variable speed motor is set in accordance with the speed of conveyor belt 5 and the desired width of channel 2a such that cams 45 form the desired channel 2a at the desired width.

Mechanical lift 36a is exemplary only, since other types of mechanical lifts could be employed which are still controlled by a linear displacement indicator 110 as in embossing step 100B.

### Alternative Shearing Control Method

An alternative method for controlling shear 30 would be to locate it at an exact multiple of the desired board length from the embossing station 35 and the first embossed channel 2a. If the speed of conveyor 5 were set at 2 feet per second, and if a controller were set to both emboss and shear at 4 second intervals, 5 second intervals or 6 second intervals, the laminate 2 will be embossed with the centers of embossed channels 2a 8 feet apart, 10 feet apart and 12 feet apart. The distance to the shear must be such that shear 30 will shear boards at the last 8 feet, 10 feet and 12 feet of the laminate. A distance “d” of 600 feet will produce 75, 60, or 50 Boards 1 every 600 feet of laminate 2:

$$75 \times 8 = 600$$

$$60 \times 10 = 600$$

$$50 \times 12 = 600$$

Thus, each board 1 that is produced at 8 feet, 10 feet and 12 feet will have half the lateral width of embossed channel 2a at each end.

### CONCLUSION

Thus, in a finished board 1, a layer of mud 11b and then a piece of drywall tape 11a and successive layers of mud 11b can be located in the adjoining embossed channel 2a halves at the ends of abutting sheets of drywall, as well as at the abutting side edges 10a which previously was the only location at which such abutting embossed channels were located. Because of the consistent, measured depth of each embossed channel 2a, the installer should be able to complete installation with a single layer of mud 11b, a layer of tape 11a, and a single top layer of mud 11b. The embossed channel is sufficiently laterally wide that a piece of drywall tape 11a can be positioned with enough room to spare that precision application of the tape 11a is not required (FIG. 5). This saves the installer time in installation, especially where each of a multiple of layers of mud 11b have to be smoothed level with a trowel, let dry and sanded.

These and other objects, advantages and features of the invention will become apparent to those of ordinary skill, and are protected within the scope of the appended claims and their equivalents.

1. A method of producing drywall board having a face layer which will be exposed when said drywall board is installed, and a back layer on the opposite side of said drywall board, comprising: forming a laminate board by compressing a gypsum slurry between said face layer and said back layer on a moving conveyor advancing said laminate; advancing said laminate to a point where the gypsum core of said laminate board is still sufficiently moist to allow a channel to be embossed into said laminate without breaking or disrupting the surface of the laminate, and yet is sufficiently dry that embossing does not cause the laminate to break apart; embossing a lateral channel into the surface of and across the width of said advancing laminate, by pressing an embossing roller into said surface of said advancing laminate for sufficient time to form said lateral embossed channel to a width which is about the width of a piece of drywall tape which would be used to tape the ends of two separate abutting drywall pieces together when being hung and taped, and to a depth sufficient to accommodate a strip of drywall tape between said embossed channel walls; shearing said laminate into separate pieces of drywall; shearing said laminate at the centerline of said embossed channel to produce individual drywall boards which each have one half of one of said embossed channels at each end of said individual drywall boards.

2. The method of claim 1 in which said embossing roller is pressed into said surface for sufficient time to form said embossed channel to a width just sufficiently wider than the drywall tape intended for use that said drywall tape can be readily positioned in said embossed channel without requiring time consuming precision, and said embossing step is performed to a depth in said surface which is sufficient to accommodate a strip of drywall tape and at least one layer of drywall mud below it and another layer above it.

3. The method of claim 2 in which said embossing step is performed at a point along the length of said advancing laminate where the moisture content of the gypsum core is between about 10% and about 25%.

4. The method of claim 2 in which said drywall board is made and pressed upside down, supported on a plurality of supporting conveyor belts which are advanced on conveyor rollers, such that said face layer will on the bottom of said laminate as it is advanced, and said back layer will be on top of said laminate as it is advanced; at said point where said laminate is still sufficiently moist to allow a channel to be embossed into said laminate without breaking or disrupting the surface of the laminate, an embossing station is located at the space between a prior of said conveyor belt rollers and the succeeding one of said conveyor belt rollers; said embossing station comprising:
an embossing roller shaped to form an embossed channel shaped depression in said laminate, oriented laterally across the underside of the width of said laminate board;
said method including pressing said embossing roller into said underside of said laminate board at spaced apart intervals as said laminate proceeds past said embossing roller which correspond to the length of drywall board one intends to manufacture.

5. The method of claim 4 which includes placing a backing roller extending laterally all the way across said back faced side of said laminate directly opposite said embossing roller, whereby said backing roller resists deformation of said laminate at said back faced side.

6. The method of claim 5 in which a lift is operably connected to said embossing roller and is used to lift said embossing roller to form said embossed channels at spaced intervals in said underside of said laminate board.

7. The method of claim 1 which includes programming and using a controller to control said embossing and shearing steps, said method, comprising: using said controller to control a lift and a, lift actuator for lifting said embossing roller, and a linear displacement indicator for providing distance information; inputting into said controller the desired channel depth and width; inputting activation of said lift actuator and said lift to lift said embossing roller into embossing position at said input channel depth; using said controller to leave said lift in said embossing position until said conveyor belt moves the length set for the width of said channel; programming said controller to lower said lift and embossing roller and leave it “at rest” until said conveyor belt moves the length which has been input for the desired board length as indicated by said linear displacement indicator; programming said controller to initiate a loop which repeats seriatim said embossing step and said “at rest” step; to thereby emboss lateral channels into said laminate at intervals equal to the length set for each individual drywall panel;
providing an Embossed Chanel Identifier, a second Linear Displacement Indicator and a Shear; programming said Embossed Channel identifier to indicate to said controller when the presence of an embossed channel is indicated; programming said shear to activate when said second linear displacement indicator indicates that conveyor belt has moved from the location indicated for said embossed channel presence ½ the set channel width and the remaining distance to said shear.

8. An apparatus used in a drywall manufacturing line for producing drywall board having a face layer which will be exposed when said drywall board is installed, and a back layer on the opposite side of said drywall board, comprising: a conveyor line in which a laminate is made and pressed upside down, supported on a plurality of supporting conveyor belts which are advanced on conveyor rollers, such that said face layer will on the bottom of said laminate as it is advanced, and said back layer will be on top of said laminate as it is advanced, with a gypsum slurry pressed between said bottom face layer and said top backing layer; at a point in said conveyor line where said laminate is at said point where said laminate is still sufficiently moist to allow a channel to be embossed into said laminate without breaking or disrupting the surface of the laminate, and yet is sufficiently dry that embossing does not cause the laminate to break apart, an embossing station is located at the space between a prior of said conveyor belt rollers and the succeeding one of said conveyor belt rollers; said embossing station comprising:
an embossing roller shaped to form an embossed channel shaped depression in said laminate, oriented laterally across the underside of the width of said laminate board; and a lift for lifting and pressing said embossing roller into said underside of said laminate at spaced apart intervals as said laminate proceeds past said embossing roller, which correspond to the length of drywall board one intends to manufacture.

9. The apparatus of claim 12 in which said lift acts to lift said embossing roller into said surface of said advancing laminate for sufficient time to form said lateral embossed channel to a width which is about the width of a piece of drywall tape which would be used to tape the ends of two separate abutting drywall pieces together when being hung and taped, and to a depth sufficient to accommodate a strip of drywall tape between said embossed channel walls; shearing said laminate into separate pieces of drywall at the centerline of said embossed channel to produce individual drywall boards which each have one half of the lateral width of one of said embossed channels at each end of said individual drywall boards.

10. The apparatus of claim 13 in which said lift is designed to press said embossing roller into said underside surface of said laminate for sufficient time to form said embossed channel to a lateral width just sufficiently wider than the drywall tape intended for use that said drywall tape can be readily positioned in said embossed channel without requiring time consuming precision, and said embossing step is performed to a depth in said surface which is sufficient to accommodate a strip of drywall tape and at least one layer of drywall mud below it and another layer above it.

11. The apparatus of claim 12 in which said embossing station is located at a point along the length of said advancing laminate where the moisture content of the gypsum core is between about 10% and about 25%.

12. The apparatus of claim 12 in which said embossing station includes a backing roller extending laterally all the way across said back faced side of said laminate directly opposite said embossing roller, whereby said backing roller resists deformation of said laminate at said back faced side.
